(19) United States
(12) Patent Application Publication
(10) Pub. No.: US 2009/0019760 A1
(43) Pub. Date: Jan. 22, 2009

(54) HOLLOW FISHING LURE WITH INTERNAL SWIMMING MECHANISM

(75) Inventor: JENS C. HAMAR, Moreno Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aqueous Outdoors, Moreno Valley, CA (US)

(21) Appl. No.: 12/141,872

(22) Filed: Jun. 18, 2008

Related U.S. Application Data
(60) Provisional application No. 60/961,095, filed on Jul. 19, 2007.

(51) Int. Cl. A01K 85/00

(52) U.S. Cl. 43/4.5; 43/42.06

(57) ABSTRACT

A fishing lure. The fishing lure includes a head part and a tail part. The head part is characterized by a rigid hollow tubular structure having a posterior opening and an anterior opening. The tail part has a blunt anterior end and a posterior tail. The blunt anterior end is attached to the head proximate to the posterior opening of the head using a vertical hinge. The fishing lure also includes a diverter flap protruding approximately midway into interior of the rigid hollow tubular structure of the head part along a vertical axis from the blunt anterior end of the tail part and vertically bisecting the blunt anterior end. In a specific embodiment, the blunt anterior end of the tail part filling and walling off the posterior opening of the head part when the tail is aligned with a horizontal axis of the head. The flow of fluid from the anterior opening of the head part to the posterior opening of the head part causes the tail part to pivot in a back and forth manner about the vertical hinge. Additionally, the diverter flap provides a stop for the pivot of the tail par.

### CROSS-REFERENCES TO RELATED APPLICATIONS

This application claims priority to U.S. Provisional Application No. 60/961,095, filed Jul. 19, 2007, commonly assigned, incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention is directed to a fishing lure. More particularly, the present invention provides a fishing lure designed to produce a natural side-to-side swimming action similar to many aquatic organism (i.e., fish, tadpole) when retrieved through a fluid, for example, a body of water. Most other conventional fishing lures are designed to imitate a swimming creature have a twisting wobble motion or a side-to-side swimming action occurs near the base of the tail. In a swimming creature, motion usually originates in the midsection of the body.

From the above, a fishing lure having a natural swimming movement to improve fishing success and enhance fishing experience is therefore desired.

### BRIEF SUMMARY OF THE INVENTION

According to embodiments of the present invention, a fishing lure is provided. More particularly, embodiments according to the present invention provide a fishing lure having a natural movement when retrieved through the water. The present fishing lure has been described using a hollow configuration. It would be recognized that the fishing lure can have other configurations.

In a specific embodiment, a fishing lure is provided. The fishing lure includes a head part. The head part has a rigid hollow tubular structure. The rigid hollow tubular structure has a posterior opening and an anterior opening. The anterior opening has an indent from a side view. Fluid is allowed to flow from the anterior opening to the posterior opening. The fishing lure includes a tail part. The tail part, the tail part has a blunt anterior end and a posterior tail. In a specific embodiment, the blunt anterior end is attached to the head proximate to the posterior opening of the head using a vertical hinge. The fishing lure includes also a diverter flap protruding approximately midway into interior of the rigid hollow cylinder of the head part along a vertical axis from the blunt anterior end of the tail part and vertically bisecting the blunt anterior end. In a specific embodiment, the blunt anterior end of the tail part fills and walls off the posterior end of the head part when the tail is aligned with a horizontal axis of the head. In a specific embodiment, the flow of fluid from the anterior opening of the head part to the posterior opening of the head part causes a rotation of the tail part in a back and forth manner pivoted at the vertical hinge and the diverter flap provides a stop for the rotation of the tail part.

Many benefits are achieved by ways of the present invention over conventional fishing lure. For example, the fishing lure according to embodiments of the present invention provides a natural swimming action that originates from a middle portion of the body. Additionally, the fishing lure can be used with conventional fishing rods and other conventional fishing equipment without substantial modification. Depending upon the embodiment, one or more these benefits may be achieved. These and other benefits will be described in more detail throughout the present specification and more particularly below.

### BRIEF DESCRIPTION OF THE DRAWINGS

FIG. 1 exemplifies various simplified perspective views of a right side of a fishing lure according to an embodiment of the present invention

FIG. 2 exemplifies various simplified side view diagrams of the fishing lure according to an embodiment of the present invention.

FIG. 3 exemplifies various simplified front view diagrams of the fishing lure according to an embodiment of the present invention

FIG. 4 exemplifies simplified top view diagrams of the fishing lure in motion according to an embodiment of the present invention.

### DETAILED DESCRIPTION OF THE INVENTION

According to embodiments of the present invention, a fishing lure is provided. More particularly, embodiments according to the present invention provide a fishing lure having a natural movement when retrieved through the water. Merely by way of example, the present fishing lure has been illustrated using a cylindrical configuration. But it would be recognized that the present invention can be in other configurations.

Before discussing the specific embodiments, elements of the fishing lure have been listed below. The elements have been described using ordinary meanings in the fishing industry and should not unduly limit the scope of the claims herein. One of ordinary skill in the art would recognize other variations, modifications, and alternatives.

### REFERENCE NUMERALS

(1) Head
(2) Tail
(3) Dam
(4) Diverter flap
(5) Hinge
(6) Hinge pin
(7) Hinge sleeve
(8) Eye
(9) Eye wire
(10) Anterior opening
(11) Posterior opening
(12) Interior cylinder wall
(13) Exterior cylinder wall
(14) Fishing line
(15) Posterior tail

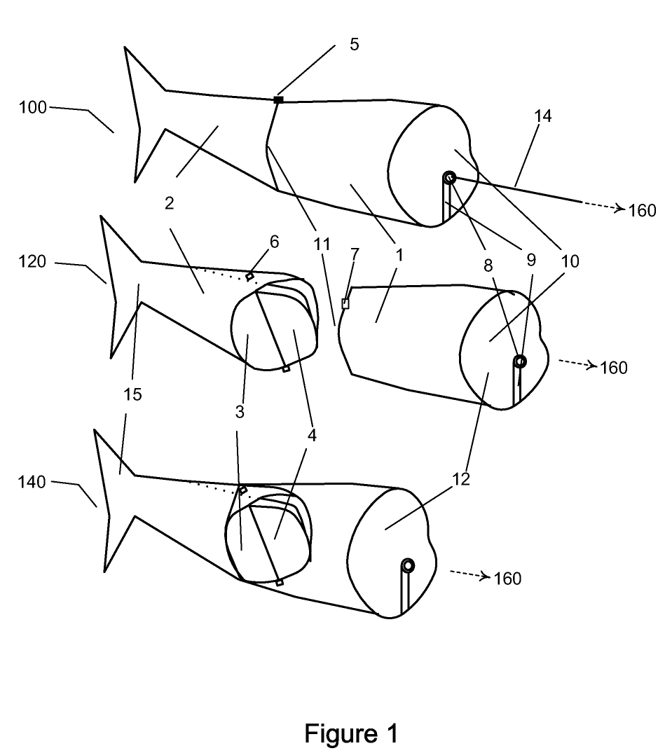

Referring to the elements above, FIG. 1 illustrates various simplified perspective view diagrams of a fishing lure according to embodiment of the present invention. These diagrams are merely examples and should not unduly limit the claims herein. One skilled in the art would recognize other variations, modifications, and alternatives. A complete assembled version 100 of the fishing lure illustrating an external appearance of the fishing lure in its entirety is shown. As shown, the lure is designed to imitate a baitfish, although there can be other types of baits, including snakes, lizards, frogs, squid, salamander, and others. Of course, there can be other variations, modifications, and alternatives.

An exploded view 120 and a transparent view 140 through the head are also shown. As shown, the fishing lure includes two parts, a head part 1 and a tail part 2. Depending upon the application, there can be more or fewer parts without departing from the scope of the claims herein. In a specific embodiment, the head part has a hollow tubular structure having an anterior opening 10 and a posterior opening 11. The hollow tubular structure can be a hollow cylindrical structure in a specific embodiment. Other geometric configuration may also be used depending on the embodiment. Such other configurations including any annular, trapezoidal, polygon, irregular, or any combination of these.

In a specific embodiment, the head part is made of a suitable material having desired characteristics. As an example, the suitable material is substantially rigid, but can also be somewhat flexible according to a specific embodiment. The material can be a plastic, a metal, wood, or any combination of these, and others. In a preferred embodiment, the material can be a polymer material such as polypropylene, polycarbonate, and the like. In certain embodiments, the material can be made of composite material such as carbon fiber, boron fiber, and others. Of course, there can be other variations, modifications, and alternatives.

The head part also includes an eye wire 9 and an eye 8, that extends into a middle of the anterior opening and protrudes from a ventral wall of the anterior opening of the head part. A fishing line 14 attaches to the eye. Alternatively, the eye wire can extends into a middle of the anterior opening and protrudes from a dorsal wall of the anterior opening of the head part. Yet in other embodiments, the eye wire can extend across the entire diameter of the anterior opening of the head part and the eye can be positioned at a center portion or other position. Or course there can be other variations, modifications, and alternatives.

The eye wire can be made of a suitable material having a desirable physical and mechanical properties in a specific embodiment. Such material can include metal, polymer, wood, or a combination of these, and others. In a specific embodiment, the eye wire can be made of a metal such as a stainless steel material, aluminum, and others. Of course there can be other variations, modifications, and alternatives.

As shown in FIG. 1, the tail part includes a blunt anterior end or a dam 3 and a posterior tail 15. In a specific embodiment, the tail part includes a diverter-flap 4 protruding from the blunt anterior end into approximately mid-way into the interior of the posterior opening of the head part. The diverter flap may be circular in shape in certain embodiments. Other shapes can quadrilateral, triangular, other annular configurations, polygon, and others, depending on the embodiment. In a specific embodiment, the widest portion of the anterior end of the tail part is just small enough to move freely within the posterior opening of the head part. As shown, the anterior end of the tail part fills and walls off the posterior opening of the head part when the tail part is aligned with a horizontal axis 160 of the hollow tubular structure of the head part. Of course there can be other modifications, variations, and alternatives.

Again referring to FIG. 1, the tail part is attached to the head part proximate to the posterior opening of the head part using a vertical hinge 5 in a mid section of the body of the fishing lure. The vertical hinge allows the tail part to move in a back and forth manner pivoted at the vertical hinge. In certain embodiments, the vertical hinge can be provided using a lateral bisecting hinge. As shown, the lateral bisecting hinge can have a dorsal attachment point and a ventral attachment point. The lateral bisecting hinge also includes a hinge sleeve 7 disposed in a vicinity of the posterior opening of the head part and a hinge pin 6 embedded in an anterior portion of the tail part. In an alternative embodiment, the tail part may be attached to the head part using a thin flexible material (for example, a soft plastic material) which can be extensions of the tail part. The tail part can be made of a flexible material in a specific embodiment. Such flexible material can include a soft plastic material such as nylon in a specific embodiment. Alternatively, the tail part can be made of a rigid material. Yet alternatively, the tail part can be made of a combination of a rigid material and a flexible material. For example, the tail part can have a rigid anterior portion and a separate flexible posterior portion depending on the embodiment. Of course there can be other variations, modifications, and alternatives.

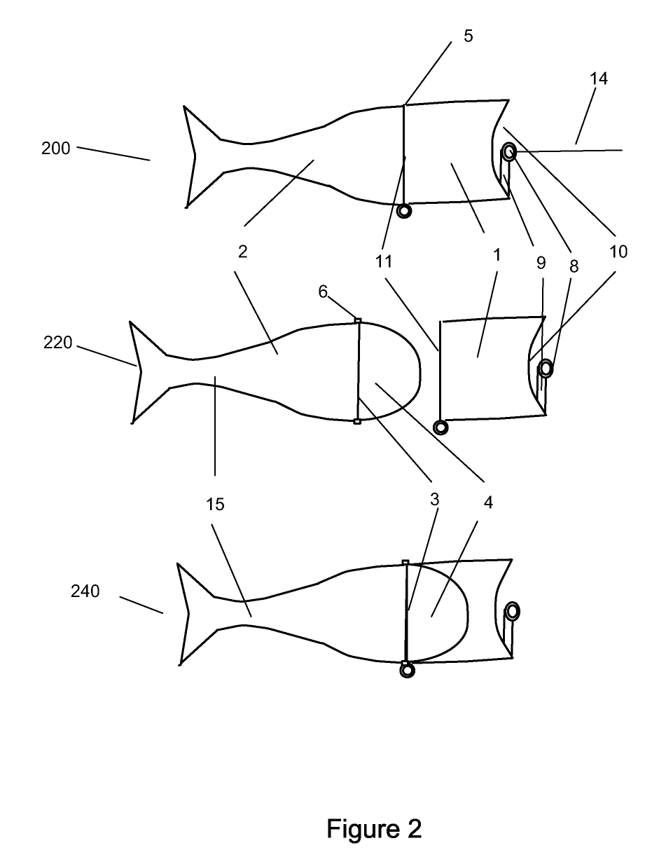

FIG. 2 shows respective direct side view diagrams of the fishing lure as illustrated in FIG. 1. These diagrams are merely examples and should not unduly limit the claims herein. One skilled in the art would recognize other variations, modifications, and alternatives. A complete assembled version of the fishing lure 200 is provided. An exploded side view is provided in 220, and a transparent side view is provided in 240. Like reference numerals are used in FIG. 2 as some of the other Figures herein.

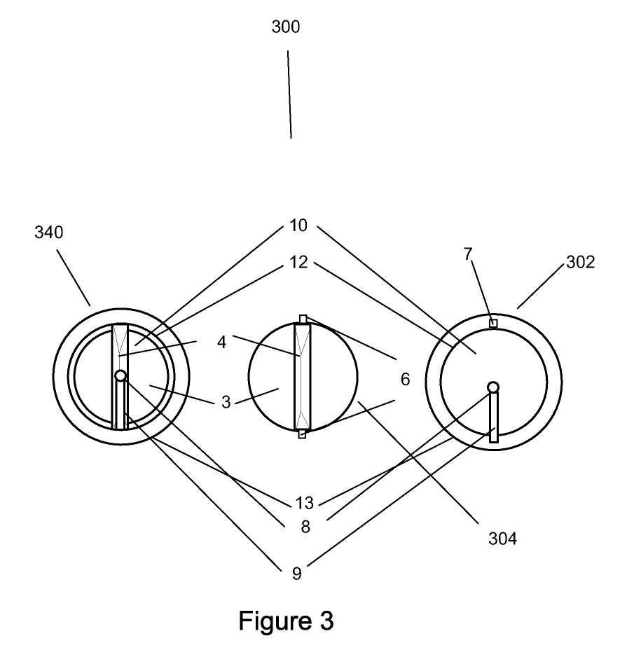

FIG. 3 shows various simplified front view diagrams of the fishing lure when the tail part is in alignment with a horizontal axis of the head part according to an embodiment of the present invention. An exploded view 300 includes a front view of the head part 302 and a front view of the tail part 304. As shown, the head part includes eye wire 9 and eye 8 for a fishing line. The eye wire extends into a middle of the anterior opening and protrudes from a ventral wall of the anterior opening of the head part in a specific embodiment. Alternatively, the eye wire can protrude from a dorsal wall of the head opening. Yet alternatively, the eye wire can extend across the anterior opening entirely depending on the application. In a specific embodiment, the fishing lure includes a hinge sleeve 7 on the head part and a hinge pin 6 on the tail part. In a specific embodiment, the hollow tubular structure of the head part includes an interior well 12 and an exterior wall 14. In a specific embodiment, the tail part includes a dam 3 and a diverter flap 4 protruding from a center portion of the dam. Of course there can be other variations, modifications, and alternatives. For example, the head part is illustrated using a circular cross section. Other geometrical configurations such as quadrilateral, triangular, other annular configuration, regular or irregular polygon, depending on the embodiments.

Referring again to FIG. 3, a front view 340 of an assembled fishing lure is illustrated. As shown, an outer perimeter of the dam of the tail part fits within the posterior opening of the head part with just enough space between the dam of the tail part and the inner wall of the head part. The tail part is attached to the head part using the hinge sleeve on the head part and a hinge pin 6 on the tail part. As shown, the hinge sleeve is configured to dispose in a posterior region on the head part and the hinge pin is configured to dispose in an anterior portion of the tail part. Of course, there can be other variations, modifications, and alternatives.

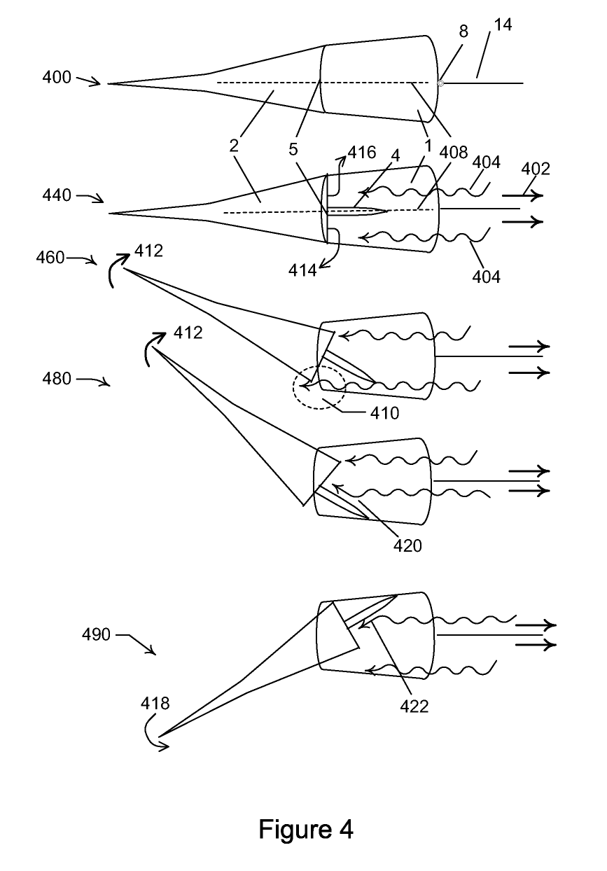

In a specific embodiment, the fishing lure can be used with conventional rod and reeling equipment. The fishing lure is attached to a fishing line using the eye and cast a distance from the user to a body of water. FIG. 4 illustrates various top view diagrams of the fishing lure in motion according to embodiments of the present invention. These diagrams are merely example and should not unduly limit the claims herein. One skilled in the art would recognize other modifications, variations, and alternatives. A top view of a complete assembled fishing lure 420 is shown. The complete fishing lure includes a head part 1, a tail part 2, a wire eye 8, and a hinge 6. As shown, a fishing line 14 is attached to the fishing lure at the eye. Like reference numerals are used in FIG. 4 as some of the other Figures herein.

Referring to FIG. 4, transparent views of the positions of the dam and the diverting flap through the hear part when the fishing lure is pulled through water are shown in 440, 460, 480, and 490. As illustrated in 440, the fishing line is pulled through water in a first direction 402. When the tail part is aligned with a horizontal axis 408 of the head part, the dam walls off from the posterior opening of the head part. When the fishing lure is dragged through the water body in the first direction, water is forced to flow through the anterior opening of the head part. Water flows through the interior of the head part in a second direction 404 and against the dam in the tail part. This forces the entire tail part to pivot in a first direction 412 resulting in an opening 410 to form between the dam and the interior wall of the posterior opening of the head part in a first side 414 of the dam. Water flows through the opening, as illustrated in 460. Momentum carries water flow and the tail part to continue to pivot in the first direction until the tail turns far enough that the diverter flap moves to a position that cuts off water flow through the opening as illustrated in reference 480. As shown, the tail part turns as far as it can go until it is stopped by the diverting flap. Water is diverted 414 to a second side of the dam by the diverting flap within the interior of the hollow structure of the head part. This causes the tail part to pivot in a second direction 418, opposite to the first direction as shown in 490 until the diverting flap moves to a position that diverts water to flow back to the first side of the dam. As shown, when a steady pull is applied to the fishing line and the fishing lure, water is forced through the interior of the head part and acts on the dam and the diverter flap causing the tail part to pivot in alternating directions continuously.

In addition to an overall basic design, there are several auxiliary characteristics of the fishing lure that can improve its function. For example, the head part can have a highly dorso-ventrally polarized weight distribution where the head part is weighted in a dorsal region. This enables the fishing lure to stay in an upright position resisting any twisting along the horizontal axis, critical for proper functioning. Polarization can be achieved in multiple ways. In a specific embodiment, the ventral portion of the head can be made of a higher density material and the dorsal half of the head can be made of a lower density material. Alternatively, the whole head can be made of a low density material ventral portion of the head is weighted. Additionally, the anterior opening of the head may be made larger than the posterior opening manifesting on a funnel-like shape that forces more water to act on the tail creating a more vigorous motion and improving function of the fishing lure. The head needs to be made of a rigid enough material so that the head can maintain its shape and does not collapse or restrict the pivoting movement of the tail part within the interior of the head. The material the tail can be rigid or flexible, or a combination. For example, an anterior portion of the tail can be rigid and having a flexible posterior portion attach to the rigid anterior portion. Of course there can be other variations, modifications, and alternatives.

It is also understood that the examples and embodiments described herein are for illustrative purposes only and that various modifications or alternatives in light thereof will be suggested to persons skilled in the art. For example, the fishing lure can have a contour resemble shape of a fish, or other animals such as a tadpole, a salamander, a lizard, a swimming rat, and others, depending on the application. It is therefore, such modifications or alternatives are to be included within the spirit and purview of this application and scope of the appended claims.

1. A fishing lure, comprising:
a head part, the head part having a rigid hollow tubular structure, the rigid hollow tubular structure having a posterior opening and an anterior opening;
a tail part, the tail part having a blunt anterior end and a posterior tail, the blunt anterior end being attached to the head proximate to the posterior opening of the head using a vertical hinge;
a diverter flap protruding approximately midway into interior of the rigid hollow tubular structure of the head part along a vertical axis from the blunt anterior end of the tail part and vertically bisecting the blunt anterior end,
wherein the blunt anterior end of the tail part filling and walling off the posterior opening of the head part when the tail is aligned with a horizontal axis of the head,
wherein fluid is allowed to flow from the anterior opening of the head part to the posterior opening of the head part to cause a rotation of the tail part in a back and forth manner pivoted at the vertical hinge, and
wherein the diverter flap provides a stop for the rotation of the tail part.

2. The fishing lure of claim 1 wherein the rigid hollow tubular structure is annular in shape.

3. The fishing lure of claim 1 wherein the rigid hollow tubular structure is quadrilateral in shape.

4. The fishing lure of claim 1 wherein the rigid hollow tubular structure is polygon in shape.

5. The fishing lure of claim 1 further comprises a wire eye extending into the middle of the anterior opening of the head part to allow attachment of a fishing line.

6. The fishing lure of claim 1 wherein the vertical hinge is a laterally bisecting hinge having a dorsal attachment point and a ventral attachment point.

7. The fishing lure of claim 1 wherein the anterior portion of the tail has a widest diameter just small enough to rotate freely within the posterior of the head.

8. The fishing lure of claim 1 wherein the vertical hinge allows for a side to side swimming motion originating from a mid body of the fishing lure.

9. The fishing lure of claim 1 wherein the diverter flap is substantially circular in shape.

10. The fishing lure of claim 1 wherein the head part has a ventral half denser than a dorsal half to maintain the fishing lure in an upright position.

11. The fishing lure of claim 1 wherein the head part is weighted in a ventral region.

12. The fishing lure of claim 1 wherein the tail part is flexible.

13. The fishing lure of claim 1 wherein the tail part is rigid.

14. The fishing lure of claim 1 wherein the tail part has a rigid anterior portion and a separate flexible posterior portion attaching to the rigid anterior portion.

15. The fishing lure of claim 1 wherein the tail part is detachable from the head part.

16. The fishing lure of claim 1 wherein the head part has a larger anterior opening than the posterior opening.

17. The fishing lure of claim 1 wherein the anterior opening of the head part is substantially the same as the posterior opening.

18. A method for using a fishing lure, the method comprising:
providing a lure having a head portion, the head portion comprising a hollow structure having an orifice, the head portion being extended to about a mid section of the lure;
casting the lure and pulling the lure through a body of water; and
allowing water to flow through the orifice and exit to cause a tail portion to move from side to side or top to bottom in a wiggling manner about the mid section of the lure.

19. The method of claim 18 wherein the tail portion is caused to moved by:
allowing water to exit the orifice and against a dam on the tail causing the tail portion to pivot in a first direction;
forming an opening between a posterior opening of the hollow structure and a first side of the dam, allowing water to flow through the opening;
stopping the tail part to pivot in the first direction using a flexible diverting flap protruding from about a center portion of the dam, the diverting flap causing water to divert to a second side of the dam, and causing the tail to pivot in a second direction opposite to the first direction.

20. The method of claim 18 wherein the casting step is provided by a rod and a reel.
